(19) United States
(12) Patent Application Publication
(10) Pub. No.: US 2018/0213103 A1
(43) Pub. Date: Jul. 26, 2018

(54) IMAGE PROCESSING APPARATUS, METHOD OF CONTROLLING THE SAME, AND STORAGE MEDIUM

(71) Applicant: CANON KABUSHIKI KAISHA, Tokyo (JP)

(72) Inventor: Yasutomo Tanaka, Toride-shi (JP)

(21) Appl. No.: 15/876,260

(22) Filed: Jan. 22, 2018

(30) Foreign Application Priority Data
Jan. 26, 2017 (JP) 2017-012540

(51) Int. Cl. H04N 1/00; G06F 13/16

(52) U.S. Cl. CPC H04N 1/00891; H04N 1/00904; H04N 1/00952; H04N 2201/0094; H04N 1/00082; G06F 13/1689; H04N 1/00034

(57) ABSTRACT

An image processing apparatus comprises a first controller that includes a plurality of processing units, a second controller that includes a plurality of processing units that include a first processing unit for executing processing in common with at least one of the plurality of processing units. The image processing apparatus measures, when executing a job by using at least one of the plurality of processing units, a memory band performance between a memory and a processing unit to be used for executing the job, and controls to cause, in a case that the measured memory band performance is higher than a predetermined value, the first processing unit to substitute processing to be executed by the at least one of the plurality of processing units, otherwise to stop power supply to the second controller.

### BACKGROUND OF THE INVENTION

### Field of the Invention

The present invention relates to an image processing apparatus, a method of controlling the same, and a storage medium.

### Description of the Related Art

A digital multi-function peripheral (MFP), which has functions such as a scanner function, a printer function, a copy function, and a facsimile transmission/reception function, includes a controller that controls the input/output operation of image data between the MFP and an external apparatus and a plurality of image processing units that perform predetermined image processing operations on image data. In order to accommodate a variety of customers, such a digital multi-function peripheral is manufactured in a wide range of models, from low speed models to high speed models, and a controller that can flexibly support the performance corresponding to each of these various models is desired. Thus, there is a controller architecture that can support the processing speed of a high speed model by enhancing a controller for a low speed model. As an example of function enhancement, there is a controller architecture that can support higher speed image processing by newly adding image processing hardware to the controller for a low speed model to improve the memory band performance. A reason why such a function enhancement is necessary is the increasing memory integration in recent digital multi-function peripherals. Since a plurality of pieces of image processing hardware share the same memory device as a work area, the memory band performance of the memory device can be a bottleneck for high-speed processing. Hence, in a high speed model, image processing hardware is added to improve the memory band performance by function enhancement.

On the other hand, there is a demand to reduce as much as possible the power consumption of a digital multi-function peripheral which includes controllers. In a main controller which is used in the aforementioned low speed model and an enhancement controller including a high-speed-model enhancement unit, it is desirable for the enhancement controller to be set to a power saving state when the enhancement unit is not used. For example, in Japanese Patent Laid-Open No. 2010-211358, a node on the main-controller side and a node on the enhancement-controller side each have a CPU, and the entire node on the enhancement-controller side is set to the power saving state when the node on the enhancement-controller side is unused. It is also disclosed that the node on the enhancement-controller side will be caused to return from the power saving state when the number of processes of the CPU in the node on the main-controller side has increased.

However, if whether to cause the enhancement unit to return to a normal state is determined in accordance with the number of processes of the CPU, the return may not always be minimum necessary from the power saving state. For example, if the memory band performance of the main controller is a bottleneck for the processing, it may not always be necessary to cause the enhancement unit to return from the power saving state even when there are a large number of processes. This is because the memory band required for processing by the main controller varies depending on the type of the processing. Thus, for example, even if there are a large number of processes, the memory band performance may not always be a bottleneck. Hence, even when the memory band performance can be a bottleneck for the processing, if whether to cause the enhancement unit to return to the normal state is determined based on only the number of processes, it will be difficult to reduce the overall power consumption including the power consumption of the enhancement unit.

### SUMMARY OF THE INVENTION

An aspect of the present invention is to eliminate the above-mentioned problem with conventional technology.

A feature of the present invention is to provide a technique of controlling processing substitution by a processing unit of a second controller based on a memory band performance of a first controller and controlling power supply to the second controller.

According to a first aspect of the present invention, there is provided an image processing apparatus comprising: a first controller that includes a plurality of processing units; a second controller that includes a plurality of processing units which include a first processing unit that executes processing in common with at least one of the plurality of processing units included in the first controller; a power supply unit that controls power supply to the first controller and the second controller; a measuring unit that measures, when executing a job by using at least one of the plurality of processing units of the first controller, a memory band performance between a memory and a processing unit to be used for executing the job; and a control unit that performs control to cause, in a case that the memory band performance measured by the measuring unit is higher than a predetermined value, the first processing unit to substitute processing to be executed by the at least one of the plurality of processing units of the first controller and to cause, in a case that the memory band performance measured by the measuring unit is not more than the predetermined value, the power supply unit to stop power supply to the second controller.

According to a second aspect of the present invention, there is provided a method of controlling an image processing apparatus including a first controller that includes a plurality of processing units, and a second controller that includes a plurality of processing units which include a first processing unit configured to execute processing in common with at least one of the plurality of processing units included in the first controller, the method comprising: measuring, when executing a job by using at least one of the plurality of processing units of the first controller, a memory band performance between a memory and a processing unit to be used for executing the job; and controlling to cause, in a case that the memory band performance measured in the measuring is higher than a predetermined value, the first processing unit to substitute processing to be executed by the at least one of the plurality of processing units of the first controller, and to stop the power supply to the second controller, in a case that the memory band performance measured in the measuring is not more than the predetermined value.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for explaining the arrangement of a digital multi-function peripheral which is an example of an image processing apparatus according to an embodiment of the present invention;

FIG. 2 is a block diagram for explaining the arrangement of a controller unit of the digital multi-function peripheral according to the embodiment;

FIG. 3 is a block diagram for explaining the arrangement of a system control unit according to the embodiment;

FIG. 4 depicts a view for explaining the structure of packet data that flows in a ring bus of the multi-function peripheral according to the embodiment;

FIG. 5A is a block diagram for explaining the arrangement of a print processing unit according to the embodiment;

FIG. 5B is a block diagram for explaining the arrangement of a loopback processing unit according to the embodiment;

FIG. 5C is a block diagram for explaining the arrangement of a scan processing unit according to the embodiment;

FIG. 6 is a block diagram for explaining the arrangement of a loopback image processor of the loopback processing unit according to the embodiment;

FIG. 7 is a block diagram for explaining the arrangement of a ring-bus switch of the multi-function peripheral according to the embodiment;

FIG. 8 is a block diagram for explaining an example of a ring-bus connection control by the ring-bus switch according to the multi-function peripheral of the embodiment and shows the connection control performed when an enhancement controller unit is not used;

FIG. 9 is a block diagram for explaining the arrangement of a ring-bus switch setting unit according to the embodiment;

FIG. 10 depicts a view for explaining the connection control performed in a case in which the ring bus is formed by connecting a main controller unit and the enhancement controller unit of the multi-function peripheral according to the embodiment;

FIG. 11 is a block diagram for explaining the arrangement of a band monitor of the main controller unit of the multi-function peripheral according to the embodiment; and

FIGS. 12A and 12B are flowcharts for describing processing performed by the main controller unit and the enhancement controller unit according to the multi-function peripheral of the embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

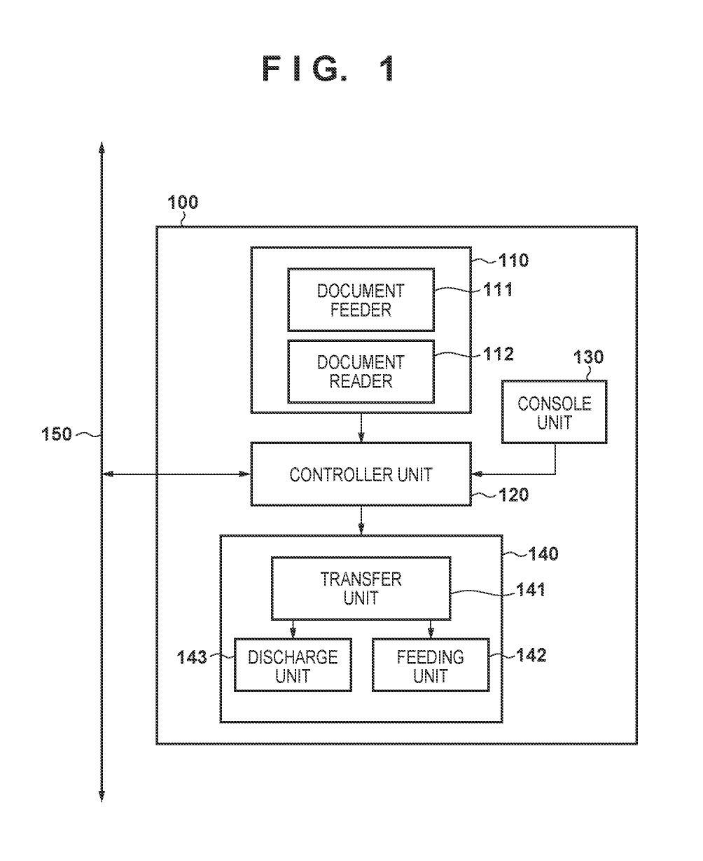

FIG. 1 is a block diagram for explaining the arrangement of a digital multi-function peripheral 100 which is an example of an image processing apparatus according to an embodiment of the present invention.

A scanner unit 110 optically reads a document and outputs image data corresponding to the image of the document. The scanner unit 110 is provided with a document reader 112 which includes a laser optical source, a lens, and the like for optically reading a document and a document feeder 111 which includes a belt for conveying the document. A printer unit 140 conveys a print medium (sheet) and prints an image on the sheet based on the image data. The printer unit 140 includes a feeding unit 142 that feeds sheets, a transfer unit 141 that transfers and fixes an image based on the image data onto a sheet, and a discharge unit 143 that can sort and staple the printed sheets and discharges the printed sheets outside the multi-function peripheral.

A controller unit 120 is electrically connected to the scanner unit 110 and the printer unit 140 and is also connected to a network 150 such as a LAN, an ISDN, the Internet/intranet, or the like. When a user is to use the copy function, the controller unit 120 controls the scanner unit 110 to obtain the image data of a document and controls the printer unit 140 to print the image of the document onto a sheet and output the printed sheet. When the scan function is to be used, the controller unit 120 controls the scanner unit 110 to obtain the image data of the document, convert the obtained image data into code data, and transmit the code data to a host PC (not shown) via the network 150. When the print function is to be used, the controller unit 120 converts the print data (code data), received from the host PC via the network 150, into image data and controls the printer unit 140 to print the image on a sheet and output the printed sheet. The controller unit 120 also has a facsimile (FAX) reception function to receive data from the ISDN or the like and print the data and a FAX transmission function to transmit the image data obtained from the scanner unit 110 to the ISDN or the like. An instruction to execute processing by each of these functions is called a job, and the digital multi-function peripheral 100 executes predetermined processing in accordance with a job corresponding to each function. A console unit 130 functions as a user interface for a user to perform an input operation and includes, for example, a display unit which has a touch panel function and a keyboard which includes various kinds of buttons.

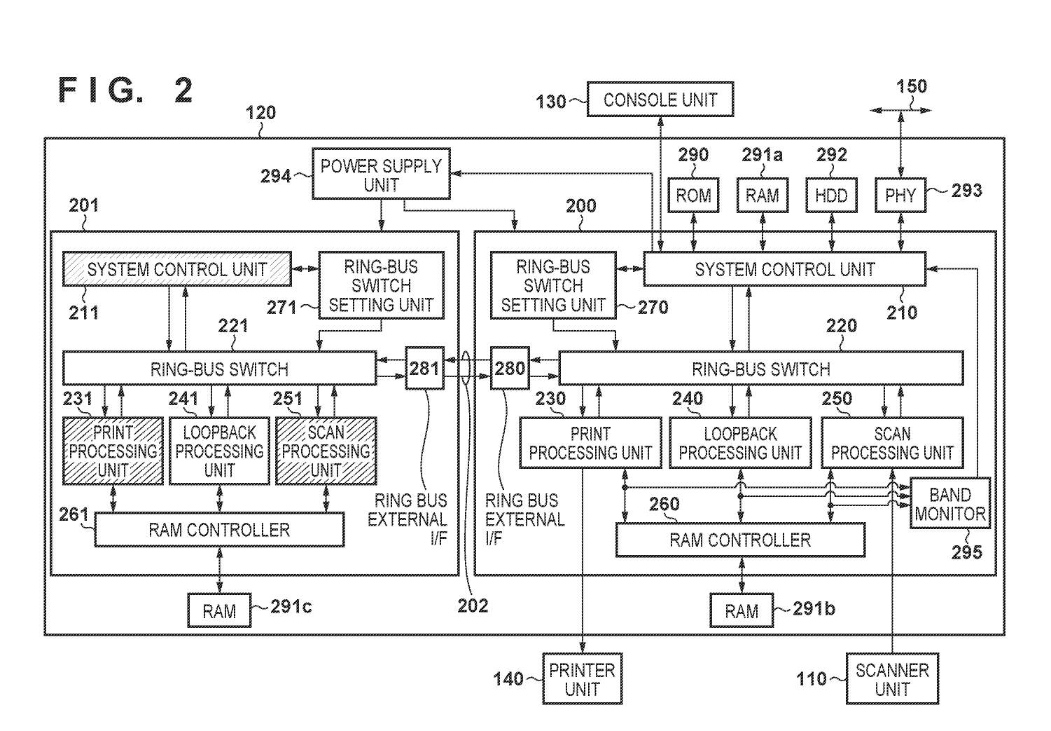

FIG. 2 is a block diagram for explaining the arrangement of the controller unit 120 of the digital multi-function peripheral 100 according to the embodiment.

The controller unit 120 includes a main controller unit 200 and an enhancement controller unit 201 for function enhancement that are connected to each other via a ring bus 202. The controller unit 120 further includes a ROM 290, RAMs 291a to 291c, an HDD (Hard Disk Drive) 292, a PHY (Physical Layer) 293, and a power supply unit 294. The units will be described in detail hereinafter. Note that in this embodiment, the main controller unit 200 and the enhancement controller unit 201 each are an independent printed circuit board such as an electronic circuit board. Assume also that the enhancement controller unit 201 has a detachable arrangement so that the user can enhance functions. The enhancement controller unit 201 has the same arrangement as that of the main controller unit 200 in the embodiment. However, as a function enhancement module, it may have any function or arrangement as long as it includes an interface capable of exchanging packet data by connecting to a ring bus. In addition, for example, each of the main controller unit 200 and the enhancement controller unit 201 may be arranged as a one-chip LSI.

The main controller unit 200 will be described first. The main controller unit 200 includes a system control unit 210, a ring-bus switch 220, a print processing unit 230, a loopback processing unit 240, and a scan processing unit 250. The main controller unit 200 also includes a RAM controller 260, a ring-bus switch setting unit 270, a ring-bus external I/F 280, and a band monitor 295.

The system control unit 210 is a control module that controls the scan processing performed in the scanner unit 110 and the print processing performed in the printer unit 140. The system control unit 210 is connected to the ring-bus switch 220 by a ring bus. The system control unit 210 also controls the transfer of image data used for scan processing or print processing via the ring-bus switch 220. Furthermore, the system control unit 210 integrally controls the overall system by controlling data transmission to the network 150, data reception from the network 150, display processing to the console unit 130, and the like.

The ring-bus switch 220 performs switch control of a ring bus used for transferring image data to the respective modules in the controller unit 120. In the embodiment, the ring bus for transferring image data to each module in the controller unit 120 is connected in a ring configuration via the ring-bus switch 220. This allows image data to be exchanged between the system control unit 210, the print processing unit 230, the loopback processing unit 240, the scan processing unit 250, and the ring-bus external I/F 280. Control of the ring-bus switch 220 is performed by the ring-bus switch setting unit 270, and the connection destination of each module on the ring bus can be changed as needed. The switch control will be described in detail later.

The print processing unit 230 performs image processing for printing such as color space conversion processing, halftone processing, and gamma correction processing on image data to be used in the printer unit 140. The print processing unit 230 receives image data via the ring-bus switch 220, performs the above-described image processing for printing on the image data, and outputs the processed image data to the printer unit 140.

The loopback processing unit 240 can execute, in each block which is to undergo an image data editing process, various kinds of image processing such as a scaling process, an image composition process, and a rotation process. The loopback processing unit 240 receives image data from the system control unit 210 via the ring-bus switch 220, performs image processing on the received data, and returns the processed image data to the system control unit 210 via the ring-bus switch 220.

The scan processing unit 250 performs, on the image data obtained in the scanner unit 110, image processing for scanning such as shading correction processing, MTF correction processing, gamma correction processing, and filter processing. The scan processing unit 250 performs image processing for scanning on the image data transferred from the scanner unit 110 and transfers the processed image data to the ring-bus switch 220. The image data transferred to the ring-bus switch 220 is transferred to the system control unit 210 via the ring bus.

The RAM controller 260 performs processing to write the image data received from the print processing unit 230, the loopback processing unit 240, or the scan processing unit 250 into the RAM 291b, read out the image data which was written into the RAM 291b, and transfer the readout image data. The print processing unit 230, the loopback processing unit 240, the scan processing unit 250 use the RAM 291b as a temporary image buffer to execute the assigned image processing operations, respectively. At this time, the image data of the print processing unit 230, the image data of the loopback processing unit 240, and the image data of the scan processing unit 250 are multiplexed and exchanged in the transfer path between the RAM controller 260 and the RAM 291b. Hence, if a data transfer that exceeds the processing performance (memory band performance) of this transfer path is requested, it causes a transfer standby state. Therefore, the data transfer between the RAM controller 260 and the RAM 291b can be a bottleneck for the processing capability of the main controller unit 200 in many cases. This memory band performance is determined by a memory device, a memory controller, and an operating frequency and is generally represented by the data transfer amount per unit time such as a MB (Megabyte)/sec. If the use band of the RAM 291b reaches the upper limit that is determined by the memory device and the operating frequency, one of the processes using the RAM 291b is made to stand by or the processes are caused to slow down. At this time, since it can lead to a system failure if the real-time processes of the print processing unit 230 and scan processing unit 250 are caused to slow down, it is necessary to ensure the memory band for real-time processing in any situation.

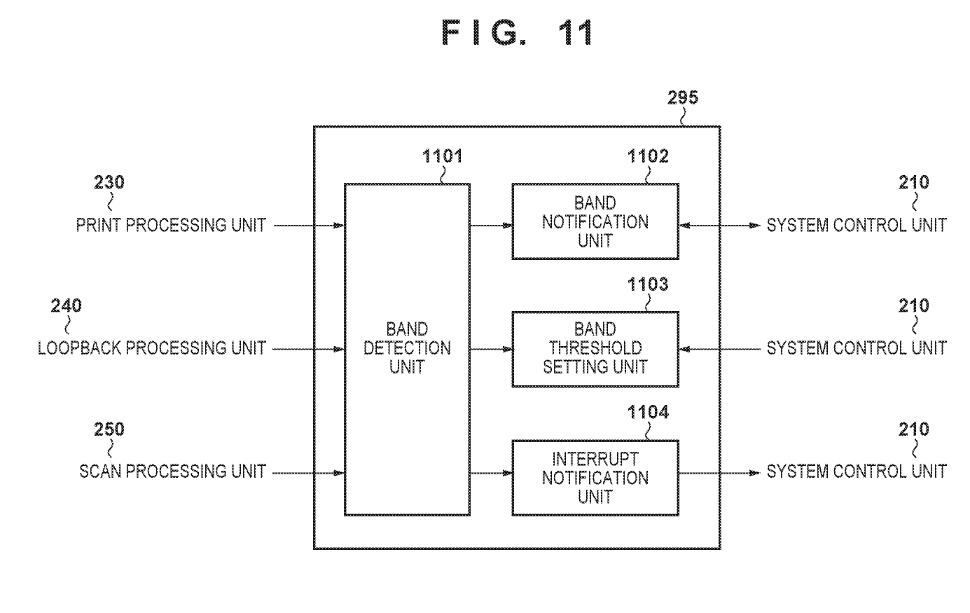

The band monitor 295 measures the memory band performance of the RAM 291b of the main controller unit 200. The band monitor 295 is connected between the RAM controller 260 and the respective processors of the print processing unit 230, the loopback processing unit 240, the scan processing unit 250 of the main controller unit 200 to monitor the use band performance of the RAM 291b. The band monitor 295 will be described in detail later with reference to FIG. 11.

The ring-bus external I/F 280 connects the main controller unit 200 and the outside via the ring-bus switch 220 and inputs/outputs packet data to/from the outside. Data transfer is performed between the main controller unit 200 and the enhancement controller unit 201 via this ring-bus external I/F 280. That is, in the embodiment, the enhancement controller unit 201 is connected to the main controller unit 200 via the ring-bus external I/F 280 and forms one ring bus 202.

Next, the enhancement controller unit 201 will be described. The enhancement controller unit 201 is a function enhancement module that increases the speed of processing of the controller unit 120. In the embodiment, the enhancement controller unit 201 is used for the purpose of increasing the memory band performance of the digital multi-function peripheral 100. As described above, there is a limit to the memory band performance of the RAM 291b of the main controller unit 200 since the memory band performance is determined by the memory device to be used and the operating frequency. Since a high speed model is required to perform image processing at a higher speed than in a mid-low speed model, the memory band performance of the image processing system can be improved by using both the main controller unit 200 and the enhancement controller unit 201.

In the embodiment, the arrangement of the enhancement controller unit 201 and the arrangement of the main controller unit 200 are the same. That is, the enhancement controller unit 201 includes a system control unit 211, a ring-bus switch 221, a print processing unit 231, a loopback processing unit 241, and a scan processing unit 251. The enhancement controller unit 201 also includes a RAM controller 261, a ring-bus switch setting unit 271, and a ring-bus external I/F 281. The functions of these units are the same as the functions of the corresponding units in the main controller unit 200. By adopting such an arrangement, it can suppress the development cost of creating a separate design for the enhancement controller unit 201 from the main controller unit 200. Note that in the embodiment, among the print processing unit 231, the loopback processing unit 241, and the scan processing unit 251 of the enhancement controller unit 201, the loopback processing unit 241 is the unit which is to be actually used as an enhancement function. This is because if the print processing unit 231 or the scan processing unit 251 is to be used, the connection to the printer unit 140 or the scanner unit 110 needs to be changed from the main controller unit 200 to the enhancement controller unit 201, and this will complicate the arrangement of the controller unit 120. In FIG. 2, the portions representing the system control unit 211, the print processing unit 231, and the scan processing unit 251 of the enhancement controller unit 201 have been grayed out and indicate that these units need not be operated. The portions that have been grayed out in FIG. 2 may be assumed to be in a power saving state in which the clock signal supply has been stopped.

The power supply unit 294 controls the power supply to the main controller unit 200 and the enhancement controller unit 201. When the power of the digital multi-function peripheral 100 is turned on, the power supply unit 294 starts supplying power to only the main controller unit 200 in the controller unit 120. The power supply to the enhancement controller unit 201 is controlled in accordance with an instruction from the system control unit 210 of the main controller unit 200. Hence, power supply to the enhancement controller unit 201 is performed only when there is a power supply instruction from the system control unit 210, and the power supply to the enhancement controller unit is stopped when there is a power supply stop instruction.

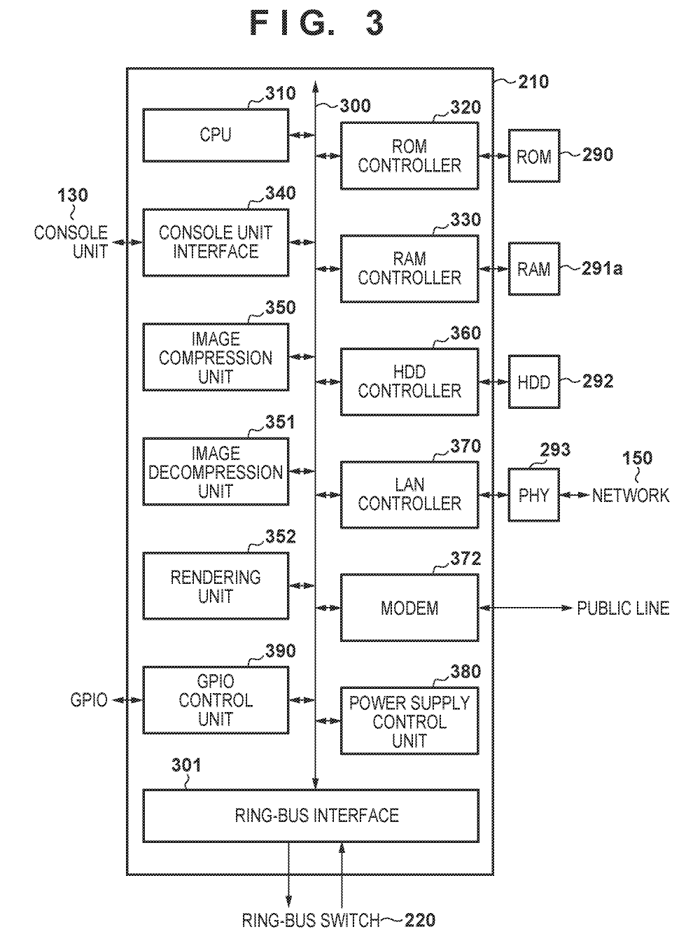

FIG. 3 is a block diagram for explaining the arrangement of the system control unit 210 according to the embodiment. Components forming the system control unit 210 will be described hereinafter. Note that the system control unit 211 of the enhancement controller unit 201 also has the same arrangement.

A CPU 310 is a processor that controls the overall digital multi-function peripheral 100. The CPU 310 integrally controls job processing operations such as print processing and scan processing in accordance with an OS (Operating System) and control programs deployed in the RAM 291a. A ROM controller 320 is a control module for accessing the ROM 290 that stores a boot program. When the digital multi-function peripheral 100 is powered on, the CPU 310 accesses the ROM 290 via the ROM controller 320 to execute the boot program and deploys a program from the HDD 292 to the RAM 291a. A RAM controller 330 is a control module for accessing the RAM 291a that is storing the control programs and image data. The RAM controller 330 includes a register to control or perform a setting operation on the RAM 291a, and this register is accessible from the CPU 310. A console unit interface 340 controls the acceptance of an operation instruction made by a user and the display of the operation result via the console unit 130. The HDD 292 stores system software, application programs, image data, and page information and job information corresponding to each set of image data. The HDD 292 is connected to a system bus 300 via an HDD controller unit 360 and writes and reads out data in accordance with an instruction from the CPU 310. A LAN controller unit 370 is connected to the network 150 via the PHY 293 and inputs/outputs information such as image data to/from an external host computer. A modem 372 is connected to a public line (not shown) and performs data communication with an external FAX device when processing a FAX transmission or FAX reception job.

An image compression unit 350 compresses image data which is to be stored in the RAM 291a or the HDD 292 into, for example, a JPEG format. An image decompression unit 351 decompresses, for example, the image data that has been compressed into a JPEG format. A rendering unit 352 converts image data (PDL data) received from the network 150 via the LAN controller unit 370 into bitmap data that can be handled in the printer unit 140.

A power control unit 380 performs, on the blocks of the main controller unit 200, power-saving control such as stopping the clock signal supply to an unused block. For example, in a power saving state, the power control unit of the system control unit 211 of the enhancement controller unit 201 stops the clock signal supply to unused blocks such as the system control unit 211, the print processing unit 231, and the scan processing unit 251.

A GPIO control unit 390 is a block that controls a GPIO (general purpose IO port) included in the controller unit 120. This block is controlled by the CPU 310 and controls the state of the GPIO. In this embodiment, a GPIO signal output from the GPIO control unit 390 is output to the outside of the system control unit 210 and is supplied to the power supply unit 294 of the controller unit 120. The power supply unit 294 stops the power supply to the enhancement controller unit 201 when the state of this GPIO signal is at low level and supplies power to the enhancement controller unit 201 when this GPIO signal is at high level. This allows the CPU 310 to control the power supply to the enhancement controller unit 201. Note that the initial state of this GPIO signal is at low level.

A ring-bus interface 301 is an interface that connects the system bus 300 of the system control unit 210 and the ring bus which is centered on the ring-bus switch 220 outside the system control unit 210. The data flowing in the ring bus is called packet data, and the ring-bus interface 301 transmits the packet data stored in the RAM 291a or the HDD 292 to the ring bus. The packet data received from the ring bus is stored in the RAM 291a or the HDD 292.

The packet data will be described next.

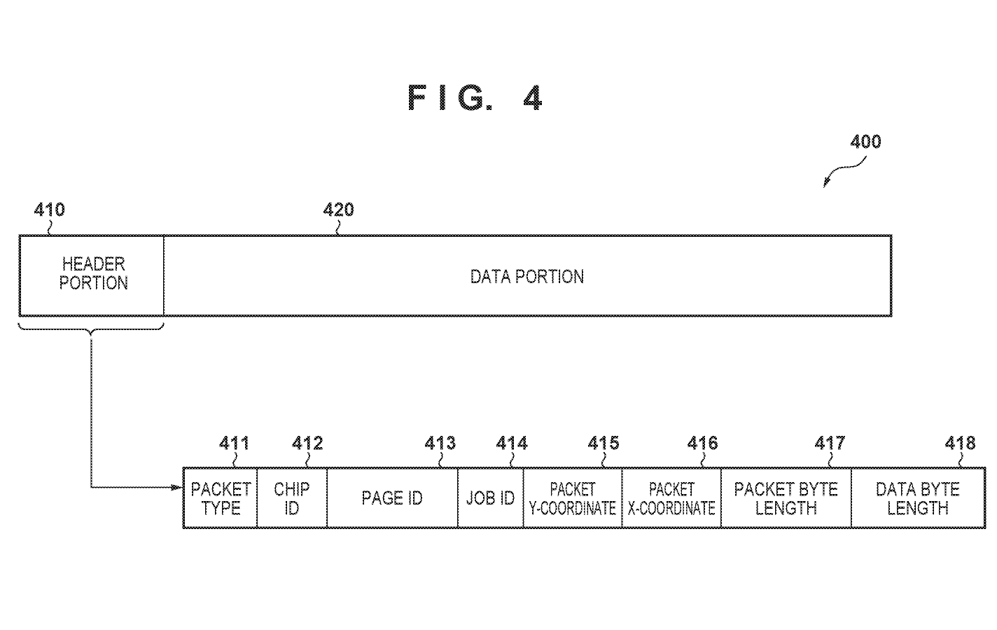

FIG. 4 depicts a view for explaining the structure of the packet data that flows in the ring bus of the multi-function peripheral 100 according to the embodiment.

A packet data 400 includes a header portion 410 and a data portion 420. The header portion 410 also includes a packet type 411, a chip ID 412, a page ID 413, a job ID 414, a packet y-coordinate 415, a packet x-coordinate 416, a packet byte length 417, and a data byte length 418.

The packet type 411 indicates whether the packet is image data or a command. If the packet type 411 indicates that the packet is image data, image data is stored in the data portion 420. On the other hand, if the packet type 411 indicates that the packet is a command, setting addresses and setting values for setting coefficients and modes of each image processing unit are stored in the data portion 420. The chip ID 412 is an ID (identifier) for identifying a target processing unit to transmit this packet. For example, if ID “0” is the print processing unit 230, ID “1” is the loopback processing unit 240, ID “2” is the scan processing unit 250, and ID “3” is the loopback processing unit 241 in the enhancement controller unit 201. The page ID 413 indicates the page number to which the packet belongs. Processing such as scanning or printing may be performed for a plurality of pages, and the page ID 413 indicates the page to which the packet belongs. The job ID 414 indicates the job number to which the packet belongs. For example, if a scan job and a print job are to be performed simultaneously, a job number is added to the packet in a manner such as a “job number 1” for the scan job packet and a “job number 2” for the print job packet so that each job can be identified. When image data is stored in the data portion 420, the packet y-coordinate 415 indicates the y-coordinate at which the image data is positioned in the page. When the image data is stored in the data portion 420, the packet x-coordinate 416 indicates the x-coordinate at which the image data is positioned in the page. The image data stored in the data portion 420 is page-unit image data that has been divided into rectangles, each having a predetermined pixel count (for example, 32 pixels×32 pixels). Hence, these x- and y-coordinates are referred to when the page data is to be regenerated from the packet data. Note that the image data has been compressed by a compressor installed in the image compression unit 350 or in each image processing unit and has been stored as compressed image data in the data portion 420. The packet byte length 417 indicates the total number of bytes of this packet, and the data byte length 418 indicates the total number of bytes of the data portion 420.

The packet data as described above flows on the ring bus. Each image processing unit receives and interprets the packet data, sets processing modes and coefficients if the packet data is a command packet or performs image processing on the image data if the packet data is an image data packet.

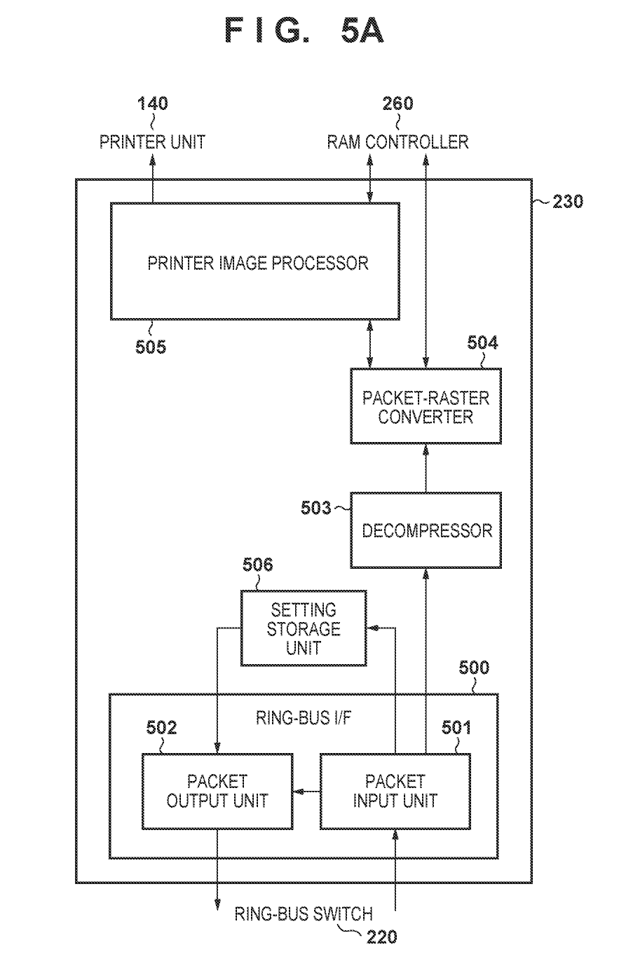

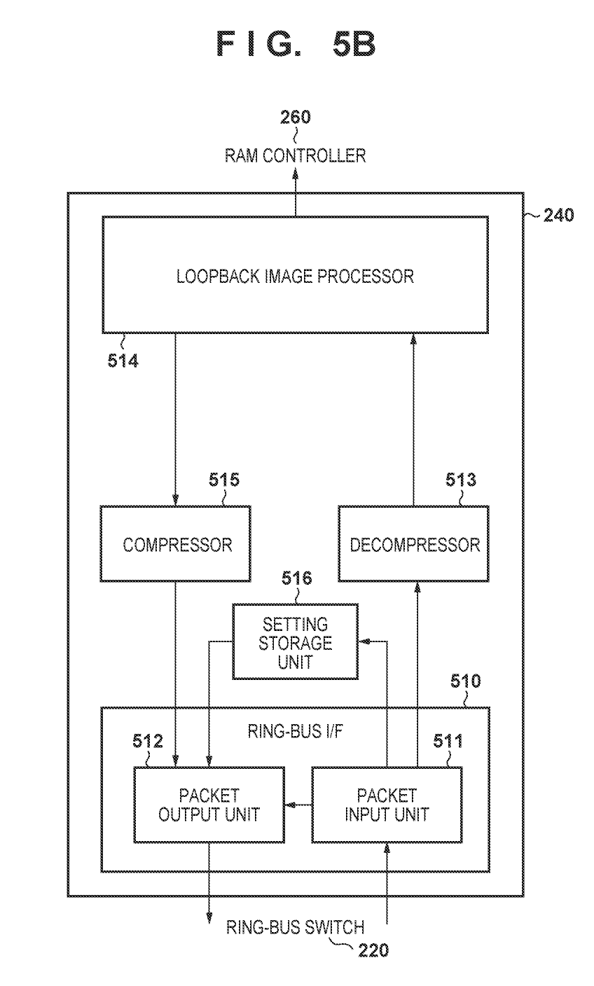

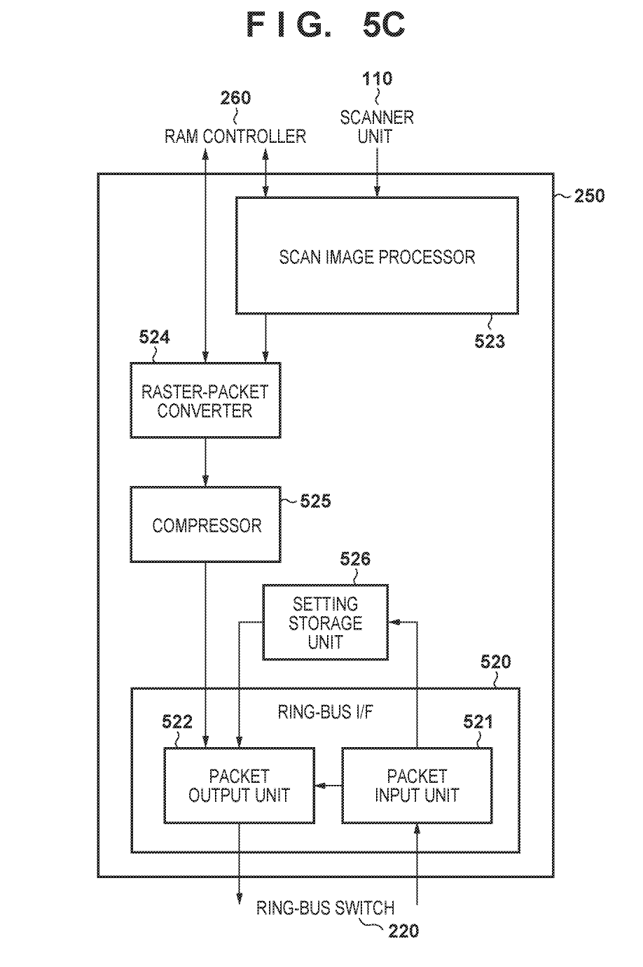

The print processing unit 230, the loopback processing unit 240, and the scan processing unit 250 according to the embodiment will be described in detail with reference to FIGS. 5A to 5C.

FIG. 5A is a block diagram for explaining the arrangement of the print processing unit 230 according to the embodiment.

A ring-bus interface (I/F) 500 is an interface that connects each unit in the print processing unit 230 to the ring bus which is centered on the ring-bus switch 220 outside the print processing unit 230. The ring-bus I/F 500 includes a packet input unit 501 and a packet output unit 502. When packet data is received, the packet input unit 501 refers to the chip ID 412 of the header portion 410 and determines whether or not it is the same as the chip ID assigned to the packet input unit 501. If the ID indicated by the chip ID 412 is different from the chip ID assigned to the packet input unit 501, the packet input unit 501 determines that received packet data is not packet data which needs to be processed and transfers the received packet data to the packet output unit 502.

On the other hand, if the ID indicated by the chip ID 412 is the same as the chip ID assigned to the packet input unit 501 and the packet is image data, the packet input unit 501 executes image processing by passing the received packet data through an internal image processing path (a decompressor 503 to a printer image processor 505). If the packet is a command, the packet input unit 501 refers to the setting addresses and the setting values stored in the data portion 420 and sets the coefficients and the modes of the designated image processing unit to a setting storage unit 506. If the packet is a command to read the setting values, the setting storage unit 506 transmits packet data storing the setting values to the ring-bus I/F 500. The decompressor 503, a packet-raster converter 504, and the printer image processor 505 perform processing based on the setting values held in the setting storage unit 506.

The packet output unit 502 arbitrates between the packet data transferred from the packet input unit 501 and the packet data from the setting storage unit 506 and transfers the sets of packet data to the ring bus. The decompressor 503 decompresses the compressed image data received from the ring-bus I/F 500 and reconstructs the data into a state which will allow subsequent image processing to be performed. The packet-raster converter 504 receives the decompressed image data from the decompressor 503 and converts it into raster image data. As described above, image data in a packet is rectangular-unit data having 32 pixels×32 pixels. Since a printing process in the printer unit 140 is performed in a raster order (line order) in the case of an image forming apparatus of an electronic photographic method, the pixel array of the image data is converted into a raster order by the packet-raster converter 504. Also in the embodiment, the RAM 291b is used as a temporary buffer for converting the image data from rectangular-unit data having 32 pixels×32 pixels into raster-order data, and the packet-raster converter 504 accesses the RAM 291b via the RAM controller 260.

The printer image processor 505 receives the image data which has been converted into the raster-order data in the above described manner from the packet-raster converter 504 and performs image processing on the image data as preprocessing for the printing to be performed by the printer unit 140. More specifically, color space conversion processing in which RGB image data is converted into CMYK image data, halftone processing by a dither method or an error diffusion method, and gamma correction processing of correcting the tone in accordance with the characteristics of the printer unit 140 are performed. Image data that has undergone such image processing is output to the printer unit 140. The printer image processor 505 also needs to output the image data to the printer unit 140 in accordance with the activation of the printer unit 140 and the feeding from the feeding unit 142. Hence, the image data is temporarily written in the RAM 291b as a buffer for standby until the appropriate timing via the RAM controller 260. Subsequently, the image data is read from the RAM 291b in synchronization with the feed timing and output to the printer unit 140.

FIG. 5B is a block diagram for explaining the arrangement of the loopback processing unit 240 according to the embodiment.

A ring-bus interface (I/F) 510 is an interface that connects each unit of the loopback processing unit 240 to the ring bus which is centered on the ring-bus switch 220 outside the loopback processing unit 240. The ring-bus I/F 510 includes a packet input unit 511 and a packet output unit 512. When the packet data is received, the packet input unit 511 refers to the chip ID 412 of the header portion 410 and determines whether the chip ID matches the chip ID assigned to the packet input unit 511. If the ID indicated by the chip ID 412 is different from the chip ID assigned to the packet input unit 511, it is determined that the received packet data is not packet data which should be processed by the packet input unit 511, and the received packet data is transferred to the packet output unit 512. On the other hand, if the ID indicated by the chip ID 412 is the same as the chip ID assigned to the packet input unit 511 and if the packet data is image data, image processing is executed by passing the received packet data through an internal image processing path (a decompressor 513 and a loopback image processor 514). Upon receiving the compressed image data after the image processing from a compressor 515, the ring-bus I/F 510 adds a header to the image data, forms the image data as packet data, and transmits the resultant packet data to the system control unit 210. If the received packet is a command, the packet input unit 511 refers to the setting addresses and the setting values stored in the data portion 420 and sets the coefficients and the modes of the designated image processing unit to a setting storage unit 516. If the packet is a command to read the setting values, the setting storage unit 516 creates packet data storing the held setting values and transmits the created packet data to the ring-bus I/F 510. The decompressor 513, the loopback image processor 514, and the compressor 515 perform processing based on the setting values held in the setting storage unit 516.

The packet output unit 512 arbitrates between the packet data transferred from the packet input unit 511, the packet data from the compressor 515, and the packet data from the setting storage unit 516 and transfers the packet data to the ring bus.

The decompressor 513 decompresses the compressed image data input from the ring-bus I/F 510 and reconstructs the image data into a pixel state capable of undergoing subsequent image processing. The compressor 515 compresses the processed image data input from the loopback image processor 514 and outputs the compressed data to the ring-bus I/F 510. Note that this compression processing is performed to form the packet data in the ring-bus I/F 510. The loopback image processor 514 receives the image data that has been decompressed by the decompressor 513 and performs the aforementioned editing image processing. This function can be used in the print processing and the scan processing, and a similar function is used also in the enhancement controller unit 201.

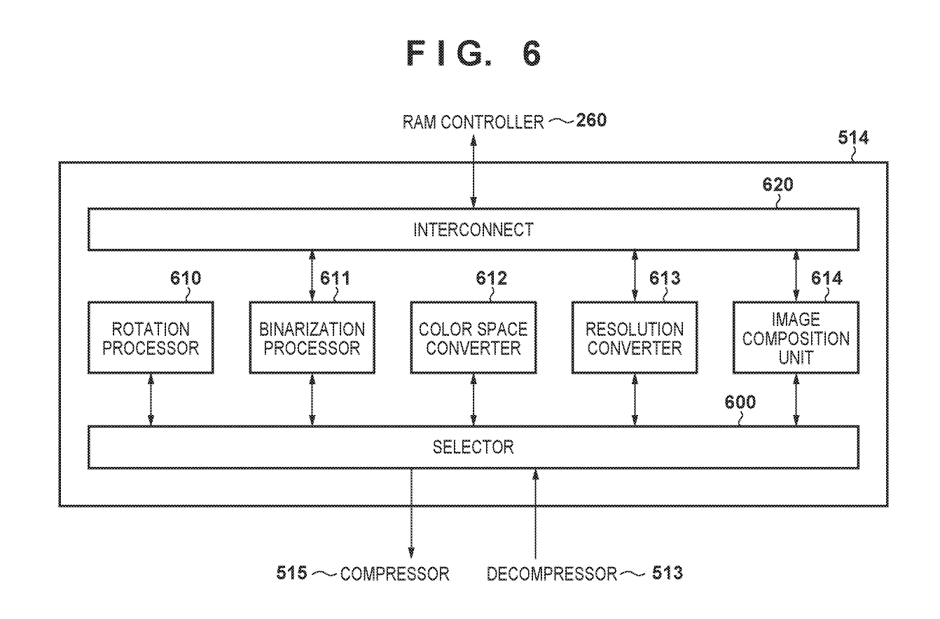

FIG. 6 is a block diagram for explaining the arrangement of the loopback image processor 514 of the loopback processing unit 240 according to the embodiment.

A selector 600 selects the internal image processor to which the image data input from the decompressor 513 or the image data output to the compressor 515 is to be connected. Before the transmission of the image data, the switching operation of the selector 600 is set by the CPU 310 by a command packet, and the connection destination is determined by the time of input/output of the image data.

A rotation processor 610 performs processing to rotate the image data. For example, the rotation processor 610 can be used to rotate an image that has been scanned as A4 portrait into A4 landscape and digitize the rotated image. Also, when printing an A4 landscape image, if the print sheet set in the feeding unit 142 is for A4 portrait and not for A4 landscape, the rotation processor 610 can be used to rotate the image. A binarization processor 611 performs processing to binarize the input multi-value data (for example, R, G, and B values, each having 8-bit tones) by the error diffusion method or the like. This is used, for example, when scanned image data is to be binarized in order to transmit the scanned image data by FAX. A color space converter 612 performs processing to convert an RGB image into a YUV image and processing to convert a YUV image into an RGB image. A resolution converter 613 performs processing to convert the resolution of input image data. For example, in the case of FAX transmission, the resolution converter 613 is used to convert scanned high-resolution image data into low-resolution image data to be used for the FAX transmission. In the case of FAX reception printing, the resolution converter 613 is used to convert the received low-resolution image data into high-resolution image data for printing. An image composition unit 614 performs processing to composite composition data such as data for printing page numbers (numbering), data for printing copy numbers, and data of a background pattern. Depending on the user who uses the digital multi-function peripheral 100, composition processing such as printing of a security-related background pattern may be used constantly, and prevention of performance degradation is desired even when the composition processing is constantly used.

An interconnect 620 is an interconnect that connects the binarization processor 611, the resolution converter 613, the image composition unit 614, and the RAM controller 260. It is difficult for the binarization processor 611 and the resolution converter 613 to perform image processing on the image data if it remains as rectangular unit-data having 32 pixels×32 pixels and will perform image processing after using the RAM 291a once to convert the image data into the raster order. In order for the binarization processor 611 to apply the error diffusion method on pixels sequentially, it is desirable for the pixels to be input in a raster order. Also, since it is necessary for the resolution converter 613 to perform filter processing when a conversion is to be performed by a bicubic method, it is desirable for the image data to undergo filter processing by converting the image data into the raster order once and accumulate the pixels in an internal line buffer. The image composition unit 614 also uses the RAM 291b as a temporary buffer to match the timings of the composition data which is transmitted as a packet and the image data which is also to be transmitted as a packet.

As described above, the loopback image processor 514 is used for various kinds of jobs. However, the loopback image processor 514 processes the image data spooled in the RAM 291a and performs processing to write the processed data back to the RAM 291a. Hence, a characteristic of the loopback image processor 514 is that a real-time characteristic is not required compared to the processes of the print processing unit 230 and the scan processing unit 250.

FIG. 5C is a block diagram for explaining the arrangement of the scan processing unit 250 according to the embodiment.

A ring-bus interface (I/F) 520 ring is an interface that connects each unit in the scan processing unit 250 to the ring bus which is centered on the ring-bus switch 220 outside the scan processing unit 250. The ring-bus I/F 520 includes a packet input unit 521 and a packet output unit 522. When packet data is received, the packet input unit 521 refers to the chip ID 412 of the header portion 410 and determines whether or not it is the same as the chip ID assigned to itself. If the ID indicated by the chip ID 412 is different from the chip ID assigned to itself, the packet input unit 521 determines that received packet data is not packet data which needs to be processed and transfers the received packet data to the packet output unit 522. On the other hand, if the ID indicated by the chip ID 412 is the same as the chip ID assigned to itself and the packet is a command, the packet input unit 521 refers to the setting addresses and the setting values stored in the data portion 420 and sets the coefficients and the modes of the designated image processing unit to a setting storage unit 526. At this time, since image data is input to the scan processing unit 250 from only the scanner unit 110, image data is not indicated in the received packet. If the packet is a command to read the setting values, the setting storage unit 526 transmits packet data storing the setting values to the ring-bus I/F 520. A scan image processor 523, a raster-packet converter 524, and a compressor 525 perform processing based on the setting values held in the setting storage unit 526. The packet output unit 522 arbitrates between the packet data transferred from the packet input unit 521 and the packet data from the setting storage unit 526 and transfers the respective sets of packet data to the ring bus.

The compressor 525 compresses the image data input from the raster-packet converter 524 and outputs the compressed image data to the subsequent ring-bus interface 520. The compression processing is performed to form the packet data in the ring-bus interface 520. The raster-packet converter 524 converts the pixel data input from the scan image processor 523 into rectangular-unit data having 32 pixels×32 pixels. As described above, since the image data in the packet is the rectangular-unit data having 32 pixels×32 pixels, the pixel data is converted into a rectangle for subsequent packet transmission.

Since the scan processing in the scanner unit 110 is performed in a raster order (line order) by using a line image sensor, the array of pixels of the image data is converted into a rectangle by the raster-packet converter 524. Also, in the embodiment, the RAM 291b is used as a temporary buffer for converting the image data from raster-order data into rectangular-unit data having 32 pixels×32 pixels, and the raster-packet converter 524 accesses the RAM 291b via the RAM controller 260.

The scan image processor 523 receives the image data from the scanner unit 110 and performs image processing such as shading correction, MTF correction, input gamma correction, and filtering. The image data that have undergone these image processing operations is output to the raster-packet converter 524. The scan image processor 523 needs to receive the image data to meet the transfer speed of the input image data so the scanning operation will not stop in the scanner unit 110. On the other hand, the transmission speed of the packet transmission by the ring-bus interface 520 does not stabilize because the transmission can be put on standby when the packet transmission timing of itself and that of other image processing units overlap. Hence, the scan image processor 523 temporarily writes, via the RAM controller 260, the image data in the RAM 291b which serves as a temporary interference image buffer until the transmission timing. Subsequently, the image data is read from the RAM 291b in synchronization with the timing of the packet transmission and the image data is transmitted to the raster-packet converter 524.

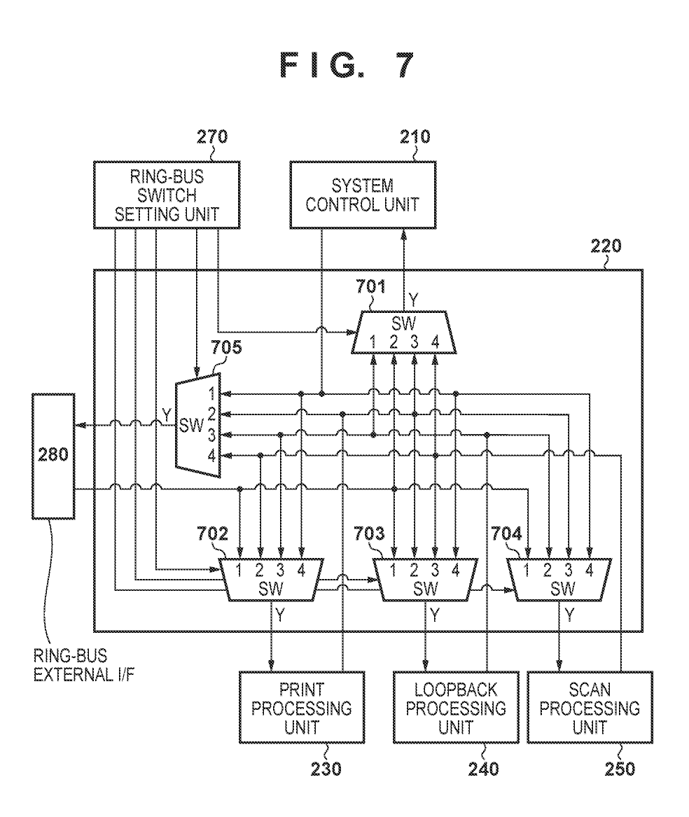

FIG. 7 is a block diagram for explaining the arrangement of the ring-bus switch 220 of the main controller unit 200 of the digital multi-function peripheral 100 according to the embodiment. Note that the structure of the ring-bus switch 221 of the enhancement controller unit 201 is the same as this arrangement.

The ring-bus switch 220 has the same number of switches as the total number of modules that may be a data transfer destination in the ring bus. The embodiment includes five switches 701 to 705 that correspond to the modules of the system control unit 210, the print processing unit 230, the loopback processing unit 240, the scan processing unit 250, and the ring-bus external I/F 280, respectively. Each of these switches (SWs) 701 to 705 can switch the connection destination via the ring bus in accordance with the value (setting value) set by the ring-bus switch setting unit 270. This allows the respective connection orders of the system control unit 210, the print processing unit 230, the loopback processing unit 240, the scan processing unit 250, and the ring-bus external I/F 280 to be changed freely on the ring bus.

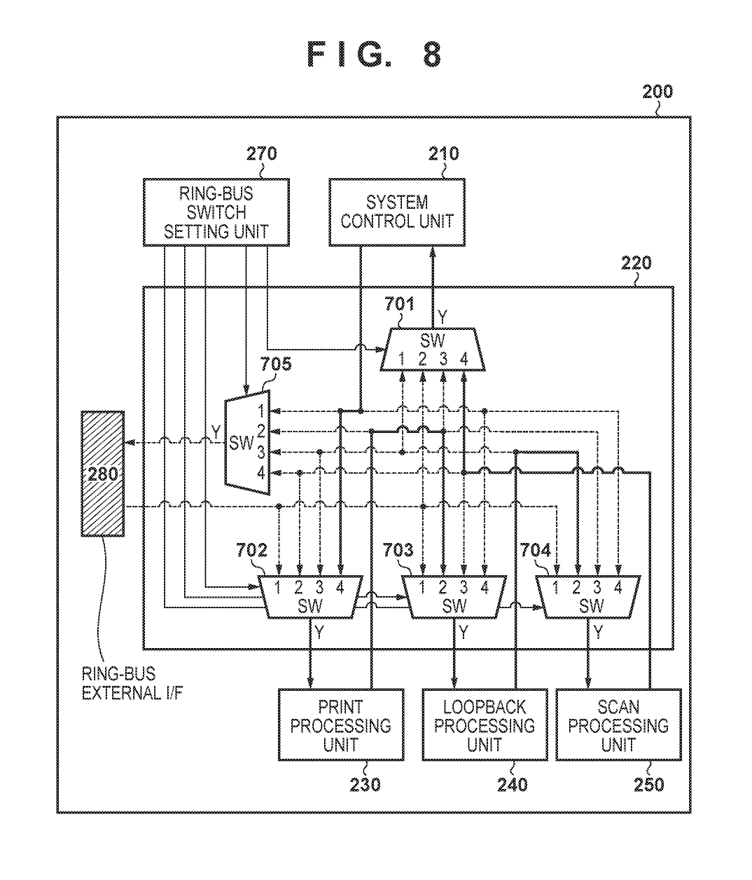

FIG. 8 is a block diagram for explaining an example of ring-bus connection control by the ring-bus switch 220 (or 221) of the multi-function peripheral 100 according to the embodiment. FIG. 8 particularly shows the connection control performed in a case in which the ring bus is completed in the main controller unit 200, that is, a case which does not use the enhancement controller unit 201.

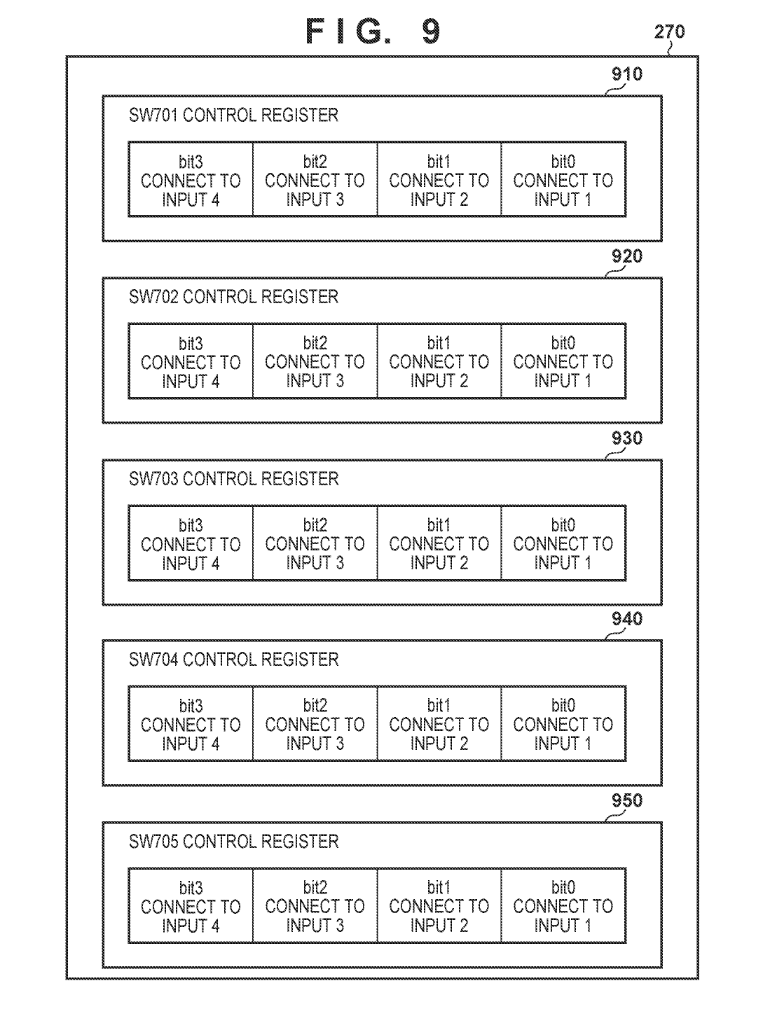

Also, FIG. 9 is a block diagram for explaining the arrangement of the ring-bus switch setting unit 270.

The ring-bus switch setting unit 270 includes registers (control registers) 910 to 950 for controlling the switches 701 to 705, respectively. Each of the control registers 910, 920, 930, 940, and 950 according to the embodiment is formed by a 4-bit register, and, for example, when “1” is set in bit0, “input 1” is connected to an output Y of a corresponding switch. In the same manner, “input 2” is connected to the output Y of the corresponding switch when “1” is set in bit1, “input 3” is connected to the output Y of the corresponding switch when “1” is set in bit3, and “input 4” is connected to the output Y of the corresponding switch when “1” is set in bit3. In this manner, a module which is to be the transfer destination of input data of each switch is specified in accordance with the value stored in each control register. The setting values (values of the respective control registers) when the connection control shown in FIG. 8 is to be performed on the ring bus are as follows.

The value of the control register 910 of the switch 701 . . . “1000” (select input 4)

The value of the control register 920 of the switch 702 . . . “1000” (select input 4)

The value of the control register 930 of the switch 703 . . . “0010” (select input 2)

The value of the control register 940 of the switch 704 . . . “0010” (select input 2)

The value of the control register 950 of the switch 705 . . . “0000” (no selection of input)

That is, when a connection is to be made in the manner of FIG. 8, the switch 701 outputs, in accordance with the setting value “1000”, the packet data from the scan processing unit 250 corresponding to “input 4” to the system control unit 210. The switch 702 outputs, in accordance with the setting value “1000”, the packet data from the system control unit 210 corresponding to “input 4” to the print processing unit 230. The switch 703 outputs, in accordance with the setting value “0010”, the packet data from the print processing unit 230 corresponding to “input 2” to the loopback processing unit 240. The switch 704 outputs, in accordance with the setting value “0010”, the packet data from the loopback processing unit 240 corresponding to “input 2” to the scan processing unit 250. The switch 705 does not output anything (the ring-bus external I/F 280 is not used) in accordance with the setting value “0000”.

By controlling the ring-bus switch 220 in this manner, the packet data is sequentially transferred starting from the system control unit 210 to the print processing unit 230, the loopback processing unit 240 and the scan processing unit 250 and is returned to the system control unit 210. As a result, an arrangement formed solely by the main controller unit 200, that is, an arrangement which does not use the enhancement controller unit 201 is provided.

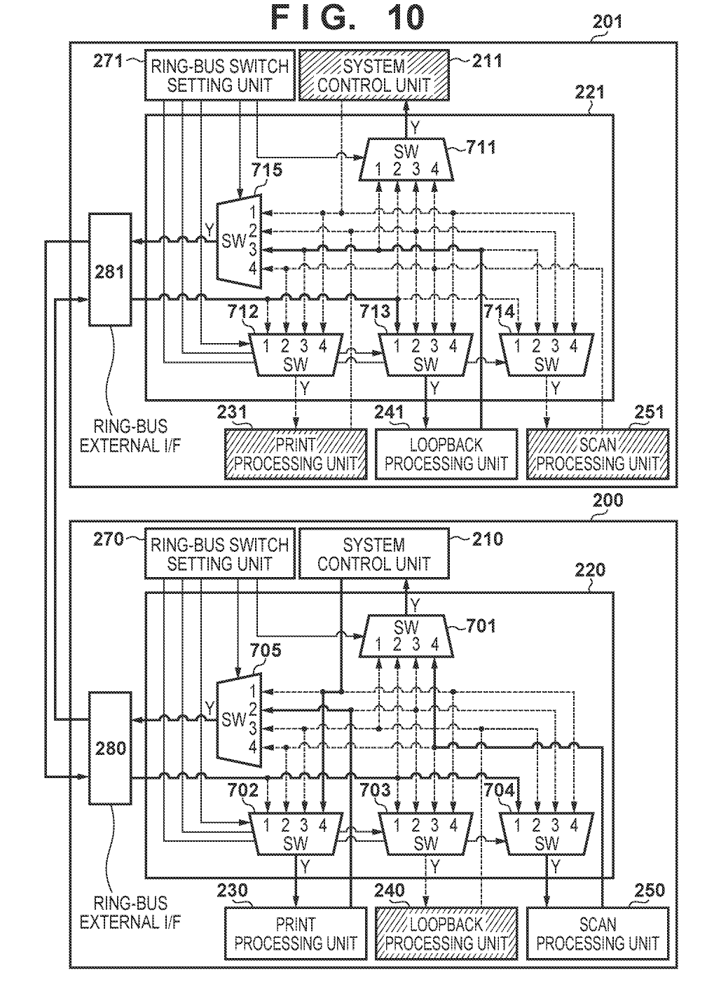

FIG. 10 depicts a view for explaining the connection control for a case in which a ring bus is formed by connecting the main controller unit 200 and the enhancement controller unit 201 of the multi-function peripheral 100 according to the embodiment. Here, the setting values (values of the respective control registers) when the connection control shown in FIG. 10 is to be performed are as follows.

The value of the control register 910 of the switch 701 . . . “1000” (select input 4)

The value of the control register 920 of the switch 702 . . . “1000” (select input 4)

The value of the control register 930 of the switch 703 . . . “0000” (no selection of input)

The value of the control register 940 of the switch 704 . . . “0001” (select input 1)

The value of the control register 950 of the switch 705 . . . “0010” (select input 2)

The value of the control register of a switch 711 . . . “0000” (no selection of input)

The value of the control register of a switch 712 . . . “0000” (no selection of input)

The value of the control register of a switch 713 . . . “0001” (select input 1)

The value of the control register of a switch 714 . . . “0000” (no selection of input)

The value of the control register of a switch 715 . . . “0100” (select input 3)

That is, when a connection is made as shown in FIG. 10, the switch 701 outputs, in accordance with the setting value “1000”, the packet data from the scan processing unit 250 corresponding to “input 4” to the system control unit 210. The switch 702 outputs, in accordance with the setting value “1000”, the packet data from the system control unit 210 corresponding to “input 4” to the print processing unit 230. The switch 703 does not output anything (the loopback processing unit 240 is not used) in accordance with the setting value “0000”. The switch 704 outputs, in accordance with the setting value “0001”, the packet data from the ring-bus external I/F 280 corresponding to “input 1” to the scan processing unit 250. The switch 705 outputs, in accordance with the setting value “0010”, the packet data from the print processing unit 230 corresponding to “input 2” to the ring-bus external I/F 280.

By controlling the ring-bus switch 220 in this manner, the packet data is sequentially transferred starting from the system control unit 210 to the print processing unit 230, the ring-bus external I/F 280, and the scan processing unit 250, and is returned to the system control unit 210.

In the ring-bus switch 221 of the enhancement controller unit 201, the switches 711, 712, and 714 do not output anything (the system control unit 211, the print processing unit 231, and the scan processing unit 251 are not used) in accordance with the setting value “0000”. The switch 713 outputs, in accordance with the setting value “0001”, the packet data from the ring-bus external I/F 281 corresponding to “input 1” to the loopback processing unit 241. The switch 715 outputs, in accordance with the setting value “0100”, the packet data from the loopback processing unit 241 corresponding to “input 3” to the ring-bus external I/F 281.

By controlling the ring-bus switch 221 in this manner, the packet data input to the enhancement controller unit 201 returns to the main controller unit 200 via the loopback processing unit 241. That is, it is possible to form a ring bus in which the packet data, starting from the system control unit 210, is sequentially transferred via the print processing unit 230, the loopback processing unit 241, and the scan processing unit 250 and is returned to the system control unit 210.

By forming the ring bus in the above-described manner, the congestion of the data transfer path to the RAM 291b can be relieved by not using the loopback processing unit 240 of the main controller unit 200. This can prevent the performance degradation of the main controller unit 200.

Note that in the embodiment, it may be arranged so that the values of these registers may be set/changed from the outside of the main controller unit 200 and the enhancement controller unit 201. For example, it may be an arrangement in which the user can set new values via the console unit 130 by using software that can edit the values of the aforementioned control registers of the ring-bus switches. In this case, the software is executed by the CPU 310 of the system control unit 210 and the system control unit 211 of the enhancement controller unit 201 is not used. Hence, changes in the control register values of the ring-bus switch setting unit 271 of the enhancement controller unit 201 will be also performed by the system control unit 210 of the main controller unit 200 via the ring-bus external I/Fs 280 and 281.

Note that in the embodiment, the enhancement controller unit 201 is assumed to have the same arrangement as the main controller unit 200. However, the enhancement controller unit 201 may have a partially different arrangement. Also, although the embodiment has an arrangement in which the ring-bus switch setting units 270 and 271 are included in the main controller unit 200 and the enhancement controller unit 201, respectively, the present invention is not limited to this. For example, the embodiment may have an arrangement in which switch control of both ring-bus switches 220 and 221 is performed by a common ring-bus switch setting unit.

FIG. 11 is a block diagram for explaining the arrangement of the band monitor 295 of the main controller unit 200 of the multi-function peripheral 100 according to the embodiment.

The band monitor 295 includes a band detection unit 1101, a band notification unit 1102, a band threshold setting unit 1103, and an interrupt notification unit 1104. The band monitor 295 is used for measuring the memory band of the RAM 291b of the main controller unit 200. That is, the band detection unit 1101 monitors the data transfer between the RAM controller 260 and each processing unit of the print processing unit 230, the loopback processing unit 240, and the scan processing unit 250 of the main controller unit 200. Subsequently, the memory band at that point of the RAM 291b is calculated. In this manner, the memory band of the RAM 291b of the main controller unit 200 obtained by the band detection unit 1101 can be read by the CPU 310 via the band notification unit 1102.

A band threshold (predetermined value) is set in the band threshold setting unit 1103 by the CPU 310. The threshold set in the band threshold setting unit 1103 is used for comparison with the memory band at that point of the RAM 291b that is measured by the band detection unit 1101. If the memory band at that point is higher than the threshold set in the band threshold setting unit 1103, the CPU 310 can be notified via the interrupt notification unit 1104. As an actual use example, assume that an upper limit or a value close to the upper limit of the memory band performance of the RAM 291b, which is determined by a memory device and an operation frequency as described above, is set to the band threshold setting unit 1103. This is then used for comparison with the memory band of the RAM 291b which is indicated by the band detection unit 1101 when the print processing unit 230, the loopback processing unit 240, and the scan processing unit 250 are used. If the used memory band of the RAM 291b indicated by the band detection unit 1101 is higher than the threshold set in the band threshold setting unit 1103, it is determined that the RAM 291b of the main controller unit 200 is congested, and power supply to the enhancement controller unit 201 is started. Next, image processing using the loopback processing unit 240 which does not require a real-time characteristic is assigned to the loopback processing unit 241 of the enhancement controller unit 201. As a result, the congestion of the RAM 291b of the main controller unit 200 is reduced, thereby preventing real-time processing from being put on standby or being delayed. It is also possible to use, when performing each image processing operation, the total value of the used memory band of the RAM 291b indicated by the band detection unit 1101 and the estimated value of the memory band which is to be used in the image processing to be executed for the comparison with the threshold set in the band threshold setting unit 1103. As a result, it is possible to determine in advance whether the memory band of the RAM 291b will reach the upper limit of the memory band performance of the RAM 291b if the image processing to be executed is performed.

On the other hand, if the used memory band of the RAM 291b indicated by the band detection unit 1101 is equal to or less than the threshold (equal to or less than the predetermined value) set in the band threshold setting unit 1103, it is determined that the band of the RAM 291b is not congested, and the processing to be executed is assigned to the enhancement controller unit 201. As a result, it is possible to consider the memory band of the RAM 291b and use the enhancement controller unit 201 only when it is shown that the memory band performance will be influenced.

In this manner, the CPU 310 can know the memory band of the RAM 291b by the band monitor 295 and use the obtained information to determine whether to use the enhancement controller unit 201.

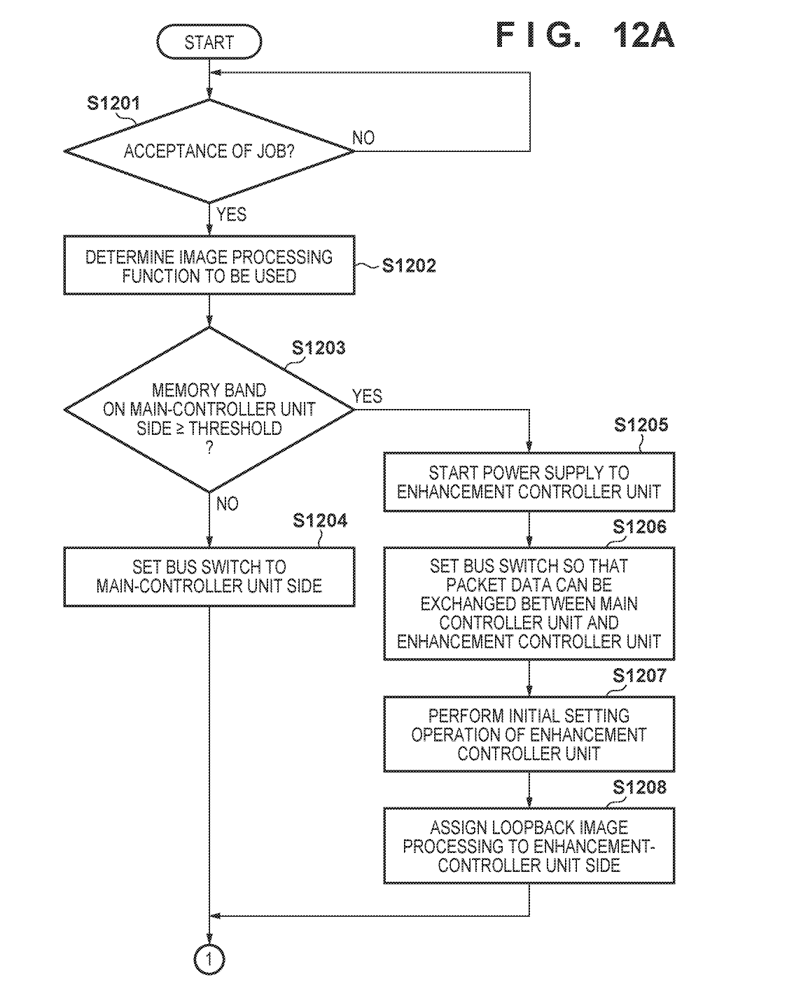

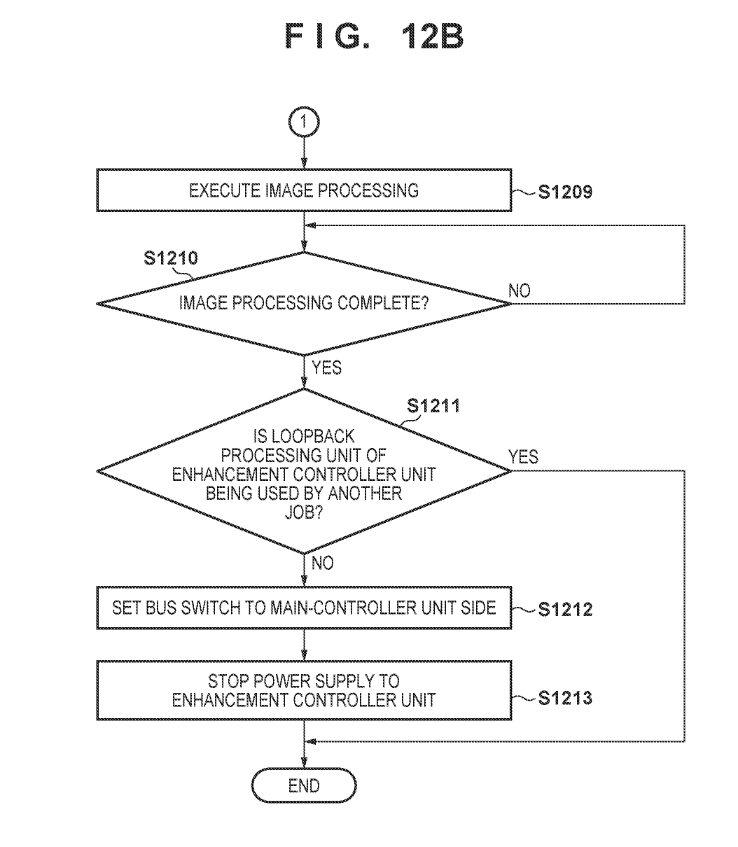

FIGS. 12A and 12B are flowcharts for describing the control of processing performed by the main controller unit 200 and the enhancement controller unit 201 in the multi-function peripheral 100 according to the embodiment. Note that the processing shown in this flowchart is implemented when the CPU 310 deploys a program stored in the HDD 292 to the RAM 291a and the CPU 310 executes the deployed program.

First, in step S1201, the CPU 310 determines whether a job has been accepted. Here, for example, if a scan job or a FAX transmission job is to be accepted from a user, the CPU 310 detects via the console unit interface 340 that the user has operated the console unit 130 and accepts the job input in accordance with the operation content. If a print job has been received from a PC or the like, the CPU 310 accepts the job input from a host computer via the network 150 and the LAN controller unit 370. If it is a FAX reception job, the CPU 310 accepts the job input via the public line and the modem 372. Upon accepting a job in this manner, the process advances to step S1202. In step S1202, the CPU 310 determines the image processing function to be used by the job accepted in step S1201, and the process advances to step S1203. More specifically, the CPU determines which processing of the print processing unit 230, the loopback processing unit 240, and the scan processing unit 250 is to be used by the accepted job.

For example, when a FAX transmission job is accepted as a job, the scan processing unit 250 is used to execute scan processing using the scanner unit 110 for FAX transmission. The loopback processing unit 240 is used to convert the scanned image data into a format transmissible by FAX. More specifically, binarization processing of the transmission image by the binarization processor 611 and conversion processing by the resolution converter 613 of converting the image data into image data having a resolution that can be transmitted by FAX are executed. That is, it is determined that two image processing units, the scan processing unit 250 and the loopback processing unit 240, will be used.

If a print job is accepted from the host computer, the print processing unit 230 is used to execute print processing using the printer unit 140. Also, for example, if the orientation of the image data to be printed which was transmitted from the host computer is different from the orientation of the print sheet set in the feeding unit 142, the image data is rotated by using the rotation processor 610 of the loopback processing unit 240. For example, if there is an instruction to composite data such as a background pattern onto the image data, the background pattern data is composited with the image data by using the image composition unit 614 of the loopback processing unit 240. In this case, two image processing units, the print processing unit 230 and the loopback processing unit 240, are used.

In general, the digital multi-function peripheral 100 can accept a plurality of jobs simultaneously, and a state in which jobs overlap is called a job conflict state. The job conflict state is generated, for example, when the digital multi-function peripheral 100 accepts a print job and a FAX transmission job almost simultaneously, and the data transfer path to the aforementioned RAM 291b will become congested when a conflict is generated among the plurality of jobs.

In step S1203, the CPU 310 confirms, before executing the image processing determined in step S1202, the current memory band of the RAM 291b indicated by the band monitor 295. Here, if the band of the RAM 291b indicated by the band monitor 295 is less than the threshold, the CPU 310 determines that the RAM 291b is not congested, and the process advances to step S1204. If the band of RAM 291b is equal to or more than the threshold, the CPU 310 determines that the RAM 291b is congested, and the process advances to step S1205. The threshold mentioned here is the upper limit or a value close to the upper limit of the memory band performance of the RAM 291b which is determined by a memory device and an operation frequency as previously explained in the description of the band monitor. As a matter of course, when performing each image processing operation, the total value obtained from adding the current memory band of the RAM 291b indicated by the band monitor 295 to the estimated value of the memory band to be used in the image processing operation which is to be executed may be used for comparison with the threshold. By setting such an arrangement, it is possible to determine in advance whether the memory band of the RAM 291b will reach the upper limit of the memory band performance of the RAM 291b if the image processing to be executed is performed.

In step S1204, the CPU 310 sets the ring-bus switch 220 to a state in which the ring bus will be completed in the main controller unit 200, and the process advances to step S1209. Since this step S1204 is performed when the CPU 310 determines that the data transfer path to the RAM 291b of the main controller unit 200 is not congested, the ring-bus switch 220 is set so the enhancement controller unit 201 will not be used as shown in FIG. 8.

On the other hand, in step S1205, the CPU 310 starts power supply to the enhancement controller unit 201. More specifically, the CPU 310 controls the GPIO control unit 390 to set the GPIO signal to high level. As a result, the power supply unit 294 of the controller unit 120 starts the power supply to the enhancement controller unit 201.

Next, the process advances to step S1206, and the CPU 310 sets the ring-bus switches 220 and 221 so that packet data can be exchanged between the main controller unit 200 and the enhancement controller unit 201 via the ring-bus external I/F 280. The specific setting is, for example, like that shown in FIG. 10. Since this step S1206 is performed when the CPU 310 determines that the data transfer path to the RAM 291b of the main controller unit 200 is congested, the ring-bus switches 220 and 221 are set so that the enhancement controller unit 201 can be used as shown in FIG. 10. The process advances to step S1207, and the CPU 310 executes the initial setting operation of the enhancement controller unit 201. This initial setting operation is for setting the loopback processing unit 241 and the RAM controller 261. In this embodiment, the CPU 310 performs various kinds of setting operations of the enhancement controller unit 201 by transmitting the packet data to the enhancement controller unit 201. Next, the process advances to step S1208, and the CPU 310 assigns the loopback image processing to the loopback processing unit 241 of the enhancement controller unit 201, and the process advances to step S1209. In step S1208, since the data transfer path to the RAM 291b of the main controller unit 200 has been determined to be congested, there is a possibility that the memory band performance of the RAM 291b will reach the upper limit if an additional image processing operation is simultaneously executed. Hence, the image processing operation of the loopback processing which does not require a real-time characteristic, in contrast to the print processing unit 230 and the scan processing unit 250, is assigned to the loopback processing unit 241 of the enhancement controller unit 201. At this time, if the loopback processing unit 240 of the main controller unit 200 is already used by another job, the processing of the loopback processing unit 240 is stopped, and the image processing is assigned again to the loopback processing unit 241 of the enhancement controller unit 201.

In step S1209, the CPU 310 controls each unit of the digital multi-function peripheral 100 to execute image processing to the accepted job. At this time, if the process advances from step S1204 to step S1209, image processing is executed by using only the main controller unit 200 of the controller unit 120, and no power is supplied to the enhancement controller unit 201. Also, if the process advances from step S1208 to S1209, the image processing is performed using both the main controller unit 200 and the enhancement controller unit 201 in the controller unit 120.

Next, the process advances to step S1210, and the CPU 310 determines whether the image processing executed in step S1209 has been completed. If the CPU 310 determines that the image processing has been completed, the process advances to step S1211. Otherwise, the CPU 310 executes step S1210. In step S1211, the CPU 310 determines whether the loopback processing unit 241 of the enhancement controller unit 201 is being used by another job. Here, if the loopback processing unit 241 of the enhancement controller unit 201 has accepted another job and is being used, the CPU 310 allows the enhancement controller unit 201 to be continuously used by the other job, and the processing ends.

On the other hand, in step S1211, if the CPU 310 determines that the loopback processing unit 241 of the enhancement controller unit 201 is not being used, the process advances to step S1212. In step S1212, the CPU 310 sets the ring-bus switches 220 and 221 so that it returns to a state in which the enhancement controller unit 201 is not used as shown in FIG. 8. Subsequently, the process advances to step S1213, and the CPU 310 stops the power supply to the enhancement controller unit 201. More specifically, the CPU 310 controls the GPIO control unit 390 and sets the GPIO signal to low level. As a result, the power supply unit 294 stops the power supply to the enhancement controller unit 201. This causes the enhancement controller unit 201 to return to a power-saving state again.

As described above, according to the embodiment, some of the functions are substituted by the enhancement controller by supplying power to the enhancement controller unit when the memory band of the RAM 291b of the main controller unit 200 is close to the upper limit of the memory band performance. As a result, it is possible to execute an accepted job by using the enhancement controller unit minimally as needed.

According to the embodiment, by performing control so that the enhancement controller unit 201 will return from a power-saving state in consideration of the memory band performance indicated by the band monitor 295, it is possible to minimize the period in which the enhancement controller unit 201 is used. As a result, power consumed by the controller unit 120 during its operation can be reduced.

In a case in which the processing is to be distributed among a plurality of processors, the load status of each processor is determined based on only the number of processes. Also, for the state of memory access conflict created by the processors, it is necessary to make a design based on the total of memory band values which are to be used in the respective processes and have been calculated on paper. Hence, it is necessary to make a design that has a sufficient margin with respect to the actual degree of memory access conflict. Therefore, there is a limit to the reduction of the overall power consumption.

In contrast, since the embodiment uses a memory band that has been actively monitored by the band monitor 295, whether the enhancement controller unit is to be used or not can be determined based on the memory band that is actually being used. As a result, it is possible to maintain the enhancement controller unit in a power-saving state more efficiently and to further reduce the power consumption of the overall apparatus.

### OTHER EMBODIMENTS

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-012540, filed Jan. 26, 2017, which is hereby incorporated by reference herein in its entirety.

What is claimed is:

1. An image processing apparatus comprising:
a first controller that includes a plurality of processing units;
a second controller that includes a plurality of processing units which include a first processing unit that executes processing in common with at least one of the plurality of processing units included in the first controller;
a power supply unit that controls power supply to the first controller and the second controller;
a measuring unit that measures, when executing a job by using at least one of the plurality of processing units of the first controller, a memory band performance between a memory and a processing unit to be used for executing the job; and
a control unit that performs control to cause, in a case that the memory band performance measured by the measuring unit is higher than a predetermined value, the first processing unit to substitute processing to be executed by the at least one of the plurality of processing units of the first controller and to cause, in a case that the memory band performance measured by the measuring unit is not more than the predetermined value, the power supply unit to stop power supply to the second controller.

2. The apparatus according to claim 1, wherein the memory band performance is a data transfer amount per unit time in a bus configured to connect the memory and the plurality of processing units of the first controller.

3. The apparatus according to claim 1, wherein the control unit causes, in accordance with the memory band performance measured by the measuring unit becoming higher than the predetermined value, the first processing unit to substitute, among the processing to be executed by the at least one of the plurality of processing units of the first controller, processing which does not require a real-time characteristic.

4. The apparatus according to claim 3, wherein the processing which does not require the real-time characteristic includes loopback image processing.

5. The apparatus according to claim 1, wherein the first controller and the second controller are connected to each other via a ring bus,
wherein the plurality of processing units of the first controller are connected via a first bus switch,
wherein the plurality of processing units of the second controller are connected via a second bus switch, and
wherein the control unit causes, by controlling the switching of the first bus switch and the second bus switch, the first processing unit to substitute the processing executed by at least one of the plurality of processing units of the first controller.

6. The apparatus according to claim 5, wherein the first controller includes a first storage that stores a setting value of the first bus switch, and the second controller includes a second storage that stores a setting value of the second bus switch.

7. The apparatus according to claim 6, wherein the control unit causes, by setting the setting value of the first storage and the setting value of the second storage, the first processing unit to substitute the processing executed by at least one of the plurality of processing units of the first controller.

8. The apparatus according to claim 6, wherein the control unit sets, when the memory band performance measured by the measuring unit is not more than the predetermined value, the setting value of the first storage so as to execute the job by only the plurality of processing units of the first controller.

9. The apparatus according to claim 1, wherein the measuring unit measures the memory band performance of the memory by being connected between the memory and the plurality of processing units of the first controller.

10. The apparatus according to claim 1, wherein the first controller is a main control unit incorporated in the image processing apparatus, and the second controller is an enhancement control unit that can be detached from the main control unit.

11. A method of controlling an image processing apparatus including a first controller that includes a plurality of processing units, and a second controller that includes a plurality of processing units which include a first processing unit configured to execute processing in common with at least one of the plurality of processing units included in the first controller, the method comprising:
measuring, when executing a job by using at least one of the plurality of processing units of the first controller, a memory band performance between a memory and a processing unit to be used for executing the job; and
controlling to cause, in a case that the memory band performance measured in the measuring is higher than a predetermined value, the first processing unit to substitute processing to be executed by the at least one of the plurality of processing units of the first controller, and to stop power supply to the second controller, in a case that the memory band performance measured in the measuring is not more than the predetermined value.

12. A non-transitory computer-readable storage medium storing a program for causing a processor to execute a method of controlling an image processing apparatus including a first controller that includes a plurality of processing units, and a second controller that includes a plurality of processing units which include a first processing unit configured to execute processing in common with at least one of the plurality of processing units included in the first controller, the method comprising:
measuring, when executing a job by using at least one of the plurality of processing units of the first controller, a memory band performance between a memory and a processing unit to be used for executing the job; and
controlling to cause, in a case that the memory band performance measured in the measuring is higher than a predetermined value, the first processing unit to substitute processing to be executed by the at least one of the plurality of processing units of the first controller, and to stop power supply to the second controller, in a case that the memory band performance measured in the measuring is not more than the predetermined value.
